(19) United States
(12) Patent Application Publication
(10) Pub. No.: US 2017/0199433 A1
(43) Pub. Date: Jul. 13, 2017

(54) TRANSVERSE-ELECTRIC-FIELD LIQUID CRYSTAL DEVICE AND METHOD FOR MANUFACTURING SAME

(71) Applicant: TOYO GOSEI CO., LTD., Chiba (JP)

(72) Inventors: Satoshi ENOMOTO, Chiba (JP); Yuki TOMA, Chiba (JP)

(73) Assignee: TOYO GOSEI CO., LTD., Chiba (JP)

(21) Appl. No.: 15/316,613

(22) PCT Filed: Jun. 5, 2015
(86) PCT No.: PCT/JP2015/066399

§ 371 Date: Dec. 6, 2016

Related U.S. Application Data
(60) Provisional application No. 62/009,049, filed on Jun. 6, 2014.

(51) Int. Cl. G02F 1/1337; C08F 22/14; C09K 19/54; G02F 1/1343; G02F 1/1334

(52) U.S. Cl. CPC G02F 1/133723; G02F 1/134363; G02F 1/133788; G02F 1/1334; C09K 19/542; C08F 22/14; G02F 2202/023; G02F 2001/134372; G02F 2001/133715; G02F 2001/133749; C09K 2019/548

(57) ABSTRACT

A transverse field liquid crystal device that is capable of restraining an increase in a pretilt angle of a liquid crystal material due to formation of a polymer layer and a manufacturing method thereof are provided. According to embodiments of the present invention, a method of manufacturing a transverse field liquid crystal device includes: forming a liquid crystal composition layer above a substrate using a liquid crystal composition including a liquid crystal material and a radically polymerizable monomer; and forming a polymer layer by irradiating the liquid crystal composition layer with light and polymerizing the radically polymerizable monomer, wherein the radically polymerizable monomer includes a compound A represented by a chemical formula (1) and a compound B represented by a chemical formula (2).

### TECHNICAL FIELD

The present invention relates to a transverse field liquid crystal device and a manufacturing method thereof.

Liquid crystal devices have been used in broad fields, such as mobile applications, monitors, and large television sets, taking advantage of the characteristics like its thinness, light weight, and low power consumption. In these fields, there is a demand for various types of performance, and various display systems (modes) have been developed. The basic configuration and the basic principle enable liquid crystal display by being provided with a pair of substrates sandwiching a liquid crystal layer and appropriately applying a voltage to electrodes over the substrates on the liquid crystal layer sides to control the alignment of liquid crystal molecules included in the liquid crystal layer, thereby controlling transmission/blocking of light (on/off of display).

Examples of the display system in recent liquid crystal devices include a vertical alignment (VA) mode to vertically align liquid crystal molecules having a negative dielectric anisotropy to the substrate surface, an in-plane switching (IPS) mode to apply a transverse field to the liquid crystal layer by horizontally aligning liquid crystal molecules having a positive or negative dielectric anisotropy to the substrate surface, a fringe field switching (FFS) mode, and the like.

As a known technique to stabilize the alignment of liquid crystal molecules, an alignment stabilization technique using a polymer (hereinafter, may be referred to as polymer sustained alignment (PSA)) (for example, refer to PTL 1). In the PSA technique, at least one of the pair of substrates is provided with an alignment layer and a liquid crystal composition including a liquid crystal material and a radically polymerizable monomer is injected between the pair of substrates for polymerization of the radically polymerizable monomer. A polymer layer is thus formed on the alignment layer to enable stabilization of the alignment of liquid crystal molecules.

### CITATION LIST

### Patent Literature

### PTL 1: WO 2012/121174

### SUMMARY OF INVENTION

### Technical Problem

A transverse field liquid crystal device operated in the IPS mode and the FFS mode preferably uses a liquid crystal material with a pretilt angle at close to 0 degrees to the alignment layer. Since conventional rubbing process gives a pretilt angle during alignment, the photo alignment system is widely employed for better performance. There is, however, a problem that photoalignment layers have weak interaction with liquid crystal and is not capable of sufficiently supporting the alignment of liquid crystal. Techniques to increase the interaction with liquid crystal while maintaining the alignment include a method applying PSA. The present inventors reviewed and have found that formation of a polymer layer using a radically polymerizable monomer of a conventional technique may cause an increase in a pretilt angle due to the formation of a polymer layer. In addition, it also has a problem from the perspective of reduction of polymerization time for formation of the polymer layer.

Some aspects of the present invention have been made in view of such circumstances and are to provide a transverse field liquid crystal device that is capable of restraining an increase in a pretilt angle of a liquid crystal material due to formation of a polymer layer and a manufacturing method thereof. Further, a transverse field liquid crystal device that enables formation of a polymer layer in a short time and a manufacturing method thereof are provided.

### Solution to Problem

A method of manufacturing a transverse field liquid crystal device according to one aspect of the present invention includes: forming a liquid crystal composition layer above a substrate using a liquid crystal composition including a liquid crystal material and a radically polymerizable monomer; and forming a polymer layer by irradiating the liquid crystal composition layer with a light and polymerizing the radically polymerizable monomer, wherein the radically polymerizable monomer includes a compound A represented by the following chemical formula (1) and a compound B represented by the following chemical formula (2).

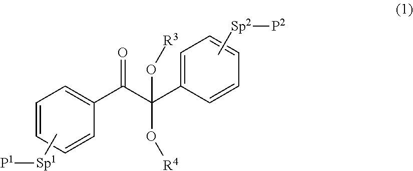

(In the formula,

R³ denotes one selected from the group consisting of a linear or branched alkyl group of which carbon number carbon number ranges from 1 to 4 and linear or branched alkenyl group of which carbon number ranges from 1 to 4,

R⁴ denotes one selected from the group consisting of a linear or branched alkyl group of which carbon number carbon number ranges from 1 to 4 and a linear or branched alkenyl group of which carbon number ranges from 1 to 4,

P¹ and P² are an identical or different from each other, and each of P¹ and P² denote a radically polymerizable group,

Sp¹ denotes one selected from the group consisting of a linear, branched, or cyclic alkylene group of which carbon number ranges from 1 to 6, a linear, branched, or cyclic alkyleneoxy group of which carbon number ranges from 1 to 6, a linear, branched, or cyclic alkylenecarbonyloxy group, of which carbon number ranges from 1 to 6 and a direct bond, and

Sp² denotes one selected from the group consisting of a linear, branched, or cyclic alkylene group of which carbon number ranges from 1 to 6, a linear, branched, or cyclic alkyleneoxy group of which carbon number ranges from 1 to 6, a linear, branched, or cyclic alkylenecarbonyloxy group of which carbon number ranges from 1 to 6 and a direct bond.)

P⁵-Sp⁵-R⁸-A¹-(Z-A²)ₙ-R⁷ (2)

(In the formula,

R⁷ denotes one selected from the group consisting of a —R⁸-Sp⁵-P⁵ group, a hydrogen atom, a halogen atom, a —CN group, a —NO₂ group, a —NCO group, a —NCS group, a —OCN group, a —SCN group, a —SF₅ group and a linear or branched alkyl group of which carbon number ranges from 1 to 18,

P⁵ denotes a radically polymerizable group,

Sp⁵ denotes one selected from the group consisting of a linear, branched, or cyclic alkylene group of which carbon number ranges from 1 to 6, a linear, branched, or cyclic alkyleneoxy group of which carbon number ranges from 1 to 6 and a direct bond, the hydrogen atom in R⁷ may be replaced by a fluorine atom or a chlorine atom, a —CH₂— group in R⁷ may be replaced by a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group, provided that an oxygen atom and a sulfur atom are not adjacent to each other,

R⁸ denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond,

A¹ and A² are identical or different from each other, and each of A¹ and A² denote a 1,2-phenylene group, a 1,3-phenylene group, a 1,4-phenylene group, a naphthalene-1,4-diyl group, a naphthalene-1,5-diyl group, a naphthalene-2,6-diyl group, a 1,4-cyclohexylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, a 1,2,3,4-tetrahydronaphthalene-2,6-diyl group, an indan-1,3-diyl group, an indan-1,5-diyl group, an indan-2,5-diyl group, a phenanthrene-1,6-diyl group, a phenanthrene-1,8-diyl group, a phenanthrene-2,7-diyl group, a phenanthrene-3,6-diyl group, an anthracene-1,5-diyl group, an anthracene-1,8-diyl group, an anthracene-2,6-diyl group, or an anthracene-2,7-diyl group,

a —CH₂— group in A¹ and A² may be replaced by a —O— group or a —S— group, provided that an oxygen atom and a sulfur atom are not adjacent to each other,

one or more hydrogen atoms in A¹ and A² may be replaced by a fluorine atom, a chlorine atom, a —CN group, an alkyl group of which carbon number ranges from 1 to 6, an alkoxy group of which carbon number ranges from 1 to 6, an alkylcarbonyl group of which carbon number ranges from 1 to 6, an alkoxycarbonyl group of which carbon number ranges from 1 to 6, or an alkylcarbonyloxy group of which carbon number ranges from 1 to 6,

Z denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond, and

n is 0, 1, or 2.)

In the method of manufacturing a liquid crystal device, it is preferred that a pretilt angle of the liquid crystal material after formation of the polymer layer ranges from 0 to 3 degrees.

In the method of manufacturing a liquid crystal device, it is preferred that a mass ratio of the compound A to the compound B in the liquid crystal composition is equal to or more than 0.05.

In the method of manufacturing a liquid crystal device, it is preferred that the mass ratio is equal to or more than 0.2.

In the method of manufacturing a liquid crystal device, it is preferred that, an amount of the compound A is equal to or more than 0.03 parts by mass per 100 parts by mass of the liquid crystal material.

In the method of manufacturing a liquid crystal device, it is preferred that the amount of the compound A is equal to or more than 0.06 parts by mass.

In the method of manufacturing a liquid crystal device, it is preferred that the compound A is represented by the following chemical formula (3).

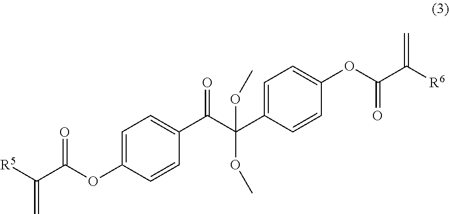

(In the formula, R⁵ and R⁶ are an identical or different from each other, and each of R⁵ and R⁶ denote a hydrogen atom or a methyl group.)

In the method of manufacturing a liquid crystal device, it is preferred that the compound B is represented by any of the following chemical formulae (4-1) to (4-5).

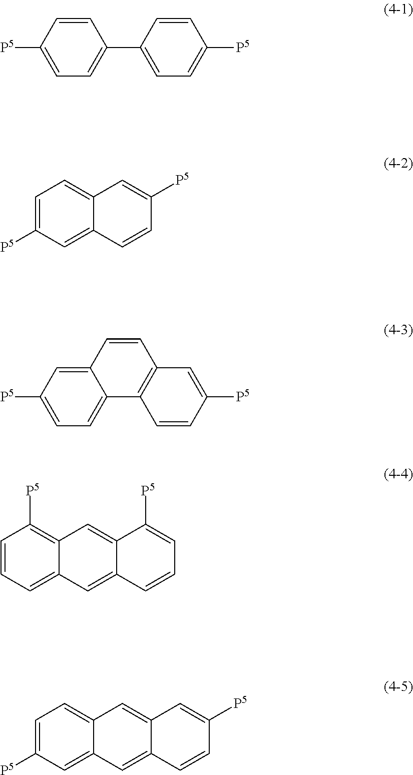

(In the formula, P⁵ is an identical or different from each other, and P⁵ denotes a radically polymerizable group.)

In the method of manufacturing a liquid crystal device, it is preferred that P⁵ is an identical or different from each other, and each of P⁵ is (meth)acryloyloxy group.

A transverse field liquid crystal device according to one aspect of the present invention includes: a substrate; a polymer layer formed above the substrate; a liquid crystal layer including a liquid crystal material above the substrate; and an electrode formed to apply a transverse field to the liquid crystal layer, wherein the polymer layer is formed by polymerizing a radically polymerizable monomer in a liquid crystal composition including the liquid crystal material and the radically polymerizable monomer, and the radically polymerizable monomer includes a compound A represented by the above chemical formula (1) and a compound B represented by the above chemical formula (2).

In the liquid crystal device, it is preferred that a pretilt angle of the liquid crystal material after formation of the polymer layer ranges from 0 to 3 degrees.

In the liquid crystal device, it is preferred that a mass ratio of the compound A to the compound B in the liquid crystal composition is equal to or more than 0.05.

In the liquid crystal device, it is preferred that the mass ratio is equal to more than 0.2.

In the liquid crystal device, it is preferred that, an amount of the compound A is equal or more than 0.03 parts by mass per 100 parts by mass of the liquid crystal material.

In the liquid crystal device, it is preferred that the amount of the compound A is equal to or more than 0.06 parts by mass.

In the liquid crystal device, it is preferred that the compound A is represented by the above chemical formula (3).

In the liquid crystal device, it is preferred that the compound B is represented by any of the above chemical formulae (4-1) to (4-5).

In the liquid crystal device, it is preferred that P⁵ is an identical or different from each other, and each of P⁵ is (meth)acryloyloxy group.

The present inventors made a keen review to reduce a pretilt angle after formation of the polymer layer and have found that formation of a polymer layer using both the compound A below and the compound B below as a radically polymerizable monomer restrains an increase in the pretilt angle of the liquid crystal material due to formation of the polymer layer to complete the present invention.

### BRIEF DESCRIPTION OF DRAWINGS

FIG. 1 is a cross-sectional schematic view illustrating a procedure of manufacturing a transverse field liquid crystal device in an embodiment of the present invention and illustrates the state before a polymerization step.

FIG. 2 is a cross-sectional schematic view illustrating a procedure of manufacturing a transverse field liquid crystal device in the embodiment of the present invention and illustrates the state after the polymerization step.

### DESCRIPTION OF EMBODIMENTS

An embodiment of the present invention is described below. Various characteristics described in the following embodiment may be combined with each other. Each characteristic establishes an independent invention.

A transverse field liquid crystal device in an embodiment of the present invention may be used for a display device, specifically such as a television set, a personal computer, a mobile phone, a monitor, and an information display, to fabricate a device with excellent display properties.

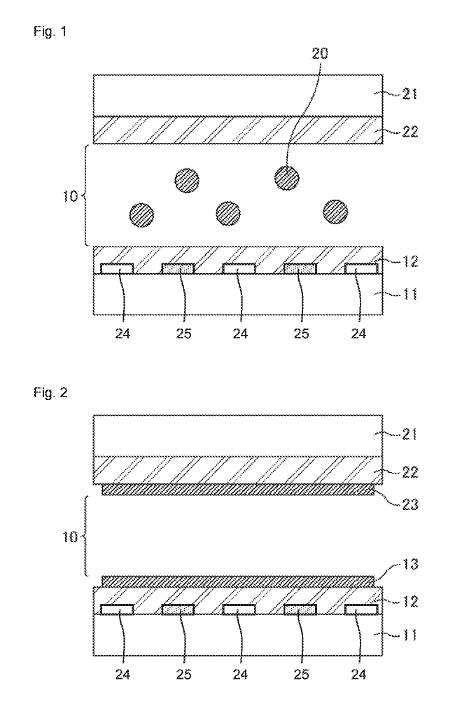

As illustrated in FIGS. 1 and 2, a transverse field liquid crystal device in the present embodiment includes an array substrate 11, a color filter substrate 21, and a liquid crystal layer 10 sandwiched between a pair of substrates composed of the array substrate 11 and the color filter substrate 21. The array substrate 11 includes an insulating transparent substrate formed from glass or the like as a material, and various types of wiring, pixel electrodes, common electrodes, thin film transistors (TFTs) and the like that are formed on the transparent substrate. The color filter substrate 21 includes an insulating transparent substrate formed from glass or the like as a material, and a color filter, a black matrix and the like that are formed on the transparent substrate. The liquid crystal device in the present embodiment is operated in a transverse field system, such as the IPS mode and the FFS mode, and has both pixel electrodes 24 and common electrodes 25 formed on the array substrate 11. Application of a voltage between the pixel electrodes 24 and the common electrodes 25 applies an electric field in a transverse direction to the liquid crystal molecules included in the liquid crystal layer 10. In an example of the IPS mode, as illustrated in FIGS. 1 and 2, the pixel electrodes 24 and the common electrodes 25 are located to be alternately aligned on the same plane. Meanwhile, in an example of the FFS mode, a common electrode 25, an insulating film, and a pixel electrodes 24 are laminated in this order to form an electric field, which is a transverse field, between the common electrode 25 and the pixel electrodes 24 through slits provided in the pixel electrodes 24.

The array substrate 11 has an alignment layer 12 formed thereon, and the color filter substrate 21 has an alignment layer 22 formed thereon. The alignment layers 12 and 22 are constituted by a polymer material having a main chain including an imide structure (polyimide) or the like. The alignment layers 12 and 22 have surfaces subjected to alignment process, thereby enabling horizontal alignment of the pretilt angle of the liquid crystal material. Examples of the measure of the alignment process include rubbing process and photo alignment process. Examples of the main component of the alignment layers include polymer compounds, such as polyimide, polyamic acid, polyamide, and polysiloxane. If the alignment layers are photoalignment layers, a polymer compound including a photoreactive functional group, such as a cinnamate group, a chalcone group, a coumalin group, a tolane group, a stilbene group, and an azobenzene group, is preferably used as a material for the photoalignment layer. One or both of the alignment layers 12 and 22 may be omitted to give alignability to the substrates themselves.

As illustrated in FIG. 1, before a PSA polymerization step, the liquid crystal layer 10 has a radically polymerizable monomer 20 therein. The radically polymerizable monomer 20 then initiates polymerization by the PSA polymerization step due to irradiation with a light to, as illustrated in FIG. 2, form polymer layers 13 and 23 on the alignment layers 12 and 22.

In the present embodiment, a liquid crystal composition includes a liquid crystal material and a radically polymerizable monomer. As the liquid crystal material, either one having a positive dielectric anisotropy or one having a negative dielectric anisotropy may be used.

As the radically polymerizable monomer, one including a compound A represented by the above chemical formula (1) and a compound B represented by the above chemical formula (2) is used. The compound A and the compound B may be respectively a compound of one or more types.

Having a structure to produce radicals due to self-cleavage, the compound A functions as a polymerization initiator. Accordingly, another polymerization initiator thus not have to be added for mixing with the liquid crystal material, and polymerization reaction is efficiently initiated only by irradiation with a light. In addition, having two or more functional groups, the compound A functions as a monomer after self-cleavage. The compound A thus does not remain as a monomer in the liquid crystal layer 10 and is incorporated into the polymer layers 13 and 23.

Accordingly, the liquid crystal layer 10 is irradiated with light to produce radicals due to self-cleavage reaction of the compound A. Using the radicals as active species, chain polymerization is successively initiated and proceeds by the radically polymerizable groups in the radically polymerizable monomer 20, and as illustrated in FIG. 2, the polymer formed by the polymerization is deposited as the polymer layers 13 and 23 on the alignment layers 12 and 22 due to phase separation.

For formation of a polymer layer using a radically polymerizable monomer of a conventional technique, the pretilt angle sometimes increases while a radically polymerizable monomer is polymerized to form the polymer layer on an alignment layer even with a pretilt angle before polymerization of the radically polymerizable monomer at approximately 0 degrees. The present inventors made keen review on how to restrain the increase in the pretilt angle while a polymer layer is formed and have found that use of a radically polymerizable monomer that includes the compound A and the compound B causes almost no increase in the pretilt angle while the polymer layers 13 and 23 are formed. Examples of the reasons for such a no increase in the pretilt angle include that use of both the compound A and the compound B decreases the molecular weight of the polymer to form the polymer layers 13 and 23 and the surfaces of the polymer layers 13 and 23 become smooth.

A pretilt angle of the liquid crystal material (liquid crystal molecules) after formation of the polymer layers 13 and 23 preferably ranges from 0 to 3 degrees, more preferably ranges from 0 to 2 degrees, even more preferably ranges from 0 to 1 degree, still more preferably ranges from 0 to 0.6 degrees, still more preferably ranges from 0 to 0.3 degrees and still more preferably ranges from 0 to 0.1 degrees, and particularly preferably is substantially none.

A mass ratio of the compound A to the compound B (compound A/compound B) in the liquid crystal composition is preferably equal to or more than 0.05 and more preferably equal to or more than 0.1, equal to or more than 0.15, or even more preferably equal to or more than 0.2. This is because a greater mass ratio decreases the molecular weight of the polymer to form the polymer layers 13 and 23, and the surfaces of the polymer layers 13 and 23 become smoother. The mass ratio is preferably equal to or less than 1 and more preferably equal to or less than 0.8. The mass ratio in the above range causes an appropriate ratio of the generated radicals to the polymerizable groups, and thus termination reaction and reduction in the degree of polymerization do not easily occur, and the polymer layers are readily formed. The mass ratio may specifically be, for example, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1, or may range between any two numbers listed here.

An amount of the compound A is preferably equal to or more than 0.03 parts by mass per 100 parts by mass of the liquid crystal material and more preferably equal to or more than 0.06 parts by mass. This is because a greater concentration of the compound A decreases the molecular weight of the polymer to form the polymer layers 13 and 23, and the surfaces of the polymer layers 13 and 23 become even smoother. The concentration of the compound A in the liquid crystal composition is preferably equal or less than 2.0 parts by mass, more preferably equal or less than 1.5 parts by mass, even more preferably equal or less than 1.0 parts by mass and still more preferably equal or less than 0.6 parts by mass. The concentration of the compound A in the liquid crystal composition in the above range causes an appropriate ratio of generated radicals to the polymerizable groups, and thus termination reaction and reduction in the degree of polymerization do not easily occur, and the polymer layers are readily formed. The concentration may specifically be, for example, 0.03, 0.04, 0.05, 0.06, 0.07, 0.08, 0.09, 0.1, 0.11, 0.12, 0.13, 0.14, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, or 2.0 parts by mass, or may range between any two numbers listed here.

Specific examples of the compound A include a compound represented by the above chemical formula (3).

Specific examples of the compound B include a compound represented by any of the above chemical formulae (4-1) to (4-5).

It is possible to manufacture the transverse field liquid crystal device by a method including: forming a liquid crystal composition layer above a substrate 11 using a liquid crystal composition including a liquid crystal material and a radically polymerizable monomer 20; and forming a polymer layer 13 by irradiating the liquid crystal composition layer with a light and polymerizing the radically polymerizable monomer 20. Use of one including the compound A and the compound B as the radically polymerizable monomer 20 enables reduction in the pretilt angle of the liquid crystal material after formation of the polymer layers 13 and 23. It is preferred to include a step of forming alignment layers 12 and 22 on at least one of a pair of substrates 11 and 21. In addition, the liquid crystal composition layer is preferably formed by injecting the liquid crystal composition between the pair of substrates 11 and 21. Note, however, that neither the use of the substrate 21 nor the use of the alignment layers 12 and 22 is essential. When the alignment layers 12 and 22 are not used, alignability is preferably given to the substrates themselves.

### EXAMPLES

Test examples to demonstrate the effects of the present invention are described below. As described below, liquid crystal cells of Evaluation Samples 1 to 16 were prepared to evaluate the sensitivity and the pretilt angle. Evaluation Samples 2, 4, 6, and from 8 to 16 are Examples of the present invention, and the rest of Evaluation Samples are Comparative Examples or Reference Examples.

TABLE 1

| | | Evaluation Samples | | | | | | | | | | | | | | | |
|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 |
| Compound A | DMABzK (parts by | | 0.05 | | 0.05 | | 0.05 | | 0.05 | 0.08 | 0.08 | 0.08 | 0.08 | 0.3 | 0.3 | 0.3 | 0.3 |
| | mass) | | | | | | | | | | | | | | | | |
| Compound B | DMABPh (parts | 0.6 | 0.6 | | | | | 0.5 | 0.5 | 0.6 | | | 0.5 | 0.6 | | | 0.5 |
| | by mass) | | | | | | | | | | | | | | | | |
| | DMANp (parts by | | | 0.6 | 0.6 | | | | | | 0.6 | | | | 0.6 | | |
| | mass) | | | | | 0.6 | 0.6 | | | | | 0.6 | | | | 0.6 | |
| | DMAPhen (parts | | | | | | | | | | | | | | | | |
| | by mass) | | | | | | | | | | | | | | | | |
| | DMAAn (parts by | | | | | | | 0.1 | 0.1 | | | | 0.1 | | | | 0.1 |
| | mass) | | | | | | | | | | | | | | | | |
| Mass Ratio | | 0 | 0.08 | 0 | 0.08 | 0 | 0.08 | 0 | 0.08 | 0.13 | 0.13 | 0.13 | 0.13 | 0.50 | 0.50 | 0.50 | 0.50 |
| (Compound A/Compound B) | | | | | | | | | | | | | | | | | |
| Irradiation Dose Until Reaching | | 150 | 1.8 | 55 | 2.2 | 35 | 2.7 | 30 | 3.3 | 1.2 | 1.4 | 1.7 | 2.1 | 0.43 | 0.55 | 0.70 | 0.84 |
| Reaction Rate of 99% (J/cm²) | | | | | | | | | | | | | | | | | |
| Pretilt Angle | Before Exposure | | | | | | | | | | | | | | | | |
| | (degrees) | <0.1 | <0.1 | <0.1 | <0.1 | <0.1 | <0.1 | <0.1 | <0.1 | <0.1 | <0.1 | <0.1 | <0.1 | <0.1 | <0.1 | <0.1 | <0.1 |
| | After Exposure | | | | | | | | | | | | | | | | |
| | (degrees) | 0.2 | <0.1 | 0.6 | <0.1 | 0.1 | <0.1 | <0.1 | <0.1 | <0.1 | <0.1 | <0.1 | <0.1 | <0.1 | <0.1 | <0.1 | <0.1 |

### 1. Preparation of Liquid Crystal Composition

A radically polymerizable monomer (the compound A and the compound B) was dissolved at a concentration shown in Table 1 in a liquid crystal material LC (Δn=0.0961, Tc=90.5° C., dielectric anisotropy ∈=9.7) to prepare liquid crystal compositions for Evaluation Samples 1 to 15. For example, in the liquid crystal composition for Evaluation Sample 1, 6.0 mg of DMABPh was dissolved in 1000 mg (mass of the liquid crystal material LC not including the radically polymerizable monomer) of the liquid crystal material LC, and in the liquid crystal composition for Evaluation Sample 2, 6.0 mg of DMABPh and 0.5 mg of DMABzK were dissolved in 1000 mg of the liquid crystal material LC.

In Table 1, the respective amounts of the compound A and the compound B to be contained are based on 100 parts by mass of the liquid crystal material LC before dissolving the compound A and the compound B.

Details of the compounds used in Table 1 are as follows.
DMABzK: 2,2-dimethoxy-1,2-di-(4-methacryloyloxy)phenylethane-1-one (synthesized in accordance with the method disclosed in WO 2012/105479)
DMABPh: 4,4′-dimethacryloyloxybiphenyl
DMANp: 2,6-dimethacryloyloxy naphthalene
DMAPhen: 2,7-dimethacryloyloxy phenanthrene
DMAAn: 2,6-dimethacryloyloxy anthracene

### 2. Evaluation of Solubility of Compound a and Compound B in Liquid Crystal Material

Each of 50 mg of DMABzK, DMABPh, DMANp, DMAPhen and DMAAn was dissolved in 500 mg of the respective liquid crystal materials LC, and stirred at 60° C. for 10 minutes. After that, they were cooled to 25° C., and residues were removed by filtration. Then, using high performance liquid chromatography (HPLC), the monomer concentration of the filtrate was measured by the internal standard method. The results are shown in Table 2.

TABLE 2

| | Solubility |
|---|---|
| Monomer | (mass %) |
| DMABzK | 0.93 |
| DMABPh | 0.62 |
| DMANp | 2.15 |
| DMAPhen | 1.96 |
| DMAAn | 0.18 |

### 3. Evaluation of Sensitivity and Pretilt Angle

A photolytic polyamic acid solution was applied as a horizontal alignment layer material respectively on a pair of glass substrates for pre-bake in the conditions at 80° C. for 5 minutes, and then post-bake in conditions at 200° C. for 60 minutes. Then, the alignment layers after post-bake were subjected to alignment process by irradiating with polarized UV light. Then, a sealant was applied on one of the pair of substrates, and the liquid crystal composition produced in “1. Preparation of Liquid Crystal Composition” was dropped on this substrate. After that, this substrate was adhered to the other of the pair of substrates to form a liquid crystal layer between the pair of substrates.

Then, while an electric field was not applied to the liquid crystal layer, the liquid crystal layer was irradiated with UV light having a peak wavelength between 320 and 370 nm for polymerization of a radically polymerizable monomer, thereby forming a polymer layer on the horizontal alignment layer to complete Evaluation Samples 1 to 15 of the liquid crystal cells.

For each Evaluation Sample, before and after UV exposure, the pretilt angle of the liquid crystal material LC was measured. The pretilt angle was measured by crystal rotation using the TBA 105 measurement system (Autronic-Melchers GmbH, Germany).

Using a UV exposure system, the irradiation dose was measured until the reaction rate of the radically polymerizable monomer in the liquid crystal layer exceeded 99% to evaluate the sensitivity. The irradiation dose was calculated by measuring the illuminance of the UV light source with a 365 nm illuminometer (UIT-150, UVD-5365 by Ushio Inc.).

The irradiation dose and the pretilt angle measured for each Evaluation Sample are shown in Table 1. The irradiation dose corresponds to the sensitivity of the radically polymerizable monomer.

In Evaluation Samples 2, 4, 6 and 8, components were identical, other than including DMABzK, to those of Evaluation Samples 1, 3, 5 and 7, respectively. In Evaluation Samples 2, 4, 6 and 8, the sensitivity was much higher than that of Evaluation Samples 1, 3, 5 and 7, respectively. This result indicates that the compound A produces more radical species than the compound B. It also indicates that the compound A had higher optical absorption and quantum yield than those of the compound B and thus produced more radical species due to degradation than the compound B.

In Evaluation Sample 7, the sensitivity was higher than that of Evaluation Sample 1. The components of Evaluation Sample 1 are identical, other than not including DMAAn, to those of Evaluation Sample 7. This result indicates that DMAAn has higher optical absorption than that of DMABPh, and thus has high radical production capability. In other words, DMAAn functions as a photoinitiator for DMABPh.

In Evaluation Samples 2, 4 and 6, the pretilt angles after exposure were smaller than those in Evaluation Samples 1, 3 and 5, respectively. This result is considered because use of the compound A as the radically polymerizable monomer increases a concentration of radical species in liquid crystal cells, and as a result, the rate of polymerization initiation reaction and termination reaction in the cells increases to produce many oligomers with a low degree of polymerization in the cells, and oligomers are deposited on the alignment layer surface due to the strong intermolecular interaction between the oligomers and the alignment layer surface. The oligomers with a low degree of polymerization deposited on the alignment layer are small in size and very close to each other. The polymer layer formed by such oligomers has a very smooth surface. In general, horizontal alignment, the liquid crystal material is aligned in parallel with the interaction surface. Accordingly, if the polymer layer has a rough surface, the pretilt angle of the liquid crystal material tends to increase due to the interaction between the liquid crystal material and the polymer layer surface. In Evaluation Samples 2, 4 and 6, however, the polymer layer surfaces were smooth, and the pretilt angle of the liquid crystal material does not increase due to the interaction between the liquid crystal material and the polymer layer surface.

In Evaluation Sample 1, the pretilt angle after exposure was smaller than that in Evaluation Sample 3. In general, when the monomer dissolved in the liquid crystal material is polymerized, and the molecular size increases, the solubility in the liquid crystal material rapidly decreases, and deposition from the liquid crystal material is readily developed. The less solubility of a monomer causes less solubility of an oligomer produced from the monomer. It is thus considered that, since the solubility of DMABPh included in Evaluation Sample 1 was less than that of DMANp included in Evaluation Sample 3, oligomers were deposited in Evaluation Sample 1 with a lower degree of polymerization than in Evaluation Sample 3 restrain, resulting in a smoother polymer layer surface, and inhibition of an increase in the pretilt angle of the liquid crystal material due to interaction between the liquid crystal material and the polymer layer surface.

In Evaluation Samples 3 and 5, the solubility in the liquid crystal material was approximately same. The pretilt angle after exposure in Evaluation Sample 5 was, however, smaller than that in Evaluation Sample 3. Evaluation Sample 5 includes DMAPhen having a phenanthrene skeleton of a tricyclic fused ring, and Evaluation Sample 3 includes DMANp having a naphthalene skeleton of a bicyclic fused ring. Since a monomer having an annelated structure, of which three or more rings are fused, such as phenanthrene, anthracene and pyrene, is bulky, phase separation liquid crystal material is prone to occur in the state of an oligomer with a low degree of polymerization. It is thus considered that, in Evaluation Sample 5, the oligomers deposited with a lower degree of polymerization than in Evaluation Sample 3, resulting in a smoother polymer layer surface, and inhibition of an increase in the pretilt angle of the liquid crystal material due to interaction between the liquid crystal material and the polymer layer surface.

In Evaluation Sample 7, the pretilt angle after exposure was smaller than that in Evaluation Sample 3. DMAAn included in Evaluation Sample 7 was bulkier and lower in the solubility in the liquid crystal material than DMANp included in Evaluation Sample 3. It is thus considered that, in Evaluation Sample 7, the oligomers were deposited due to the phase separation with a lower degree of polymerization than Evaluation Sample 3, resulting in a smoother polymer layer surface, and inhibition of an increase in the pretilt angle of the liquid crystal material due to interaction between the liquid crystal material and the polymer layer surface.

In Evaluation Sample 7, the pretilt angle after exposure was smaller than that in Evaluation Sample 3. DMAAn included in Evaluation Sample 7 was bulkier and lower in the solubility in the liquid crystal material than DMANp included in Evaluation Sample 3. It is thus considered that, in Evaluation Sample 7, the oligomers were deposited due to phase separation with a lower degree of polymerization than Evaluation Sample 3, resulting in a smoother polymer layer surface, and inhibition of an increase in the pretilt angle of the liquid crystal material due to interaction between the liquid crystal material and the polymer layer surface.

In Evaluation Samples 9, 10, 11 and 12, the irradiation doses until a reaction rate of 99% were less than the irradiation doses in Evaluation Samples 2, 4, 6 and 8, indicating that PSA formation in a short time is allowed. This is considered because the increase in the concentration of the compound A causes efficient absorption of light and an increase in radical production to increase the rate of polymerization initiation reaction and termination reaction in the cells. Moreover, each of these Evaluation Samples achieved the tilt angle<0.1, and it is thus considered to enable reduction of procedure time, and alignment support without increasing the pretilt angle of the liquid crystal material by increasing the amount of the compound A.

In Evaluation Samples 13, 14, 15 and 16, the irradiation doses until a reaction rate of 99% were even less than the irradiation doses in Evaluation Samples 9, 10, 11 and 12, and reached a reaction rate of 99% with a very illuminance of 1 J/cm² or less. This indicates that PSA formation for a very short time is allowed. Moreover, each of these Evaluation Samples achieved the tilt angle<0.1, and it is considered that, even when radical production is increased by adding the compound A at a high concentration, the oligomers with a low degree of polymerization develop phase separation to deposit on an alignment layer surface, and thus support the alignment without increasing the pretilt angle of the liquid crystal material due to interaction between the liquid crystal material and the polymer layer surface.

1. A method of manufacturing a transverse field liquid crystal device, comprising:
forming a liquid crystal composition layer above a substrate using a liquid crystal composition including a liquid crystal material and a radically polymerizable monomer; and
forming a polymer layer by irradiating the liquid crystal composition layer with a light and polymerizing the radically polymerizable monomer,
wherein
the radically polymerizable monomer includes a compound A represented by the following chemical formula (1) and a compound B represented by the following chemical formula (2): 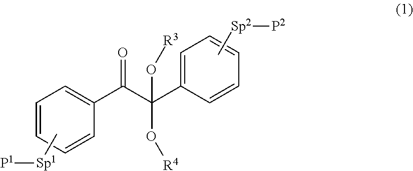
where:
R³ denotes one selected from the group consisting of:
a linear or branched alkyl group of which carbon number ranges from 1 to 4; and
a linear or branched alkenyl group of which carbon number ranges from 1 to 4;
R⁴ denotes a linear or branched alkyl, or alkenyl group of which carbon number ranges from 1 to 4;
P¹ and P² are an identical or different from each other, and each of P¹ and P² denote a radically polymerizable group;
Sp¹ denotes one selected from the group consisting of:
a linear, branched, or cyclic alkylene group of which carbon number ranges from 1 to 6;
a linear, branched, or cyclic alkyleneoxy group of which carbon number ranges from 1 to 6;
a linear, branched, or cyclic alkylenecarbonyloxy group of which carbon number
ranges from 1 to 6; and
a direct bond; and
Sp² denotes one selected from the group of:
a linear, branched, or cyclic alkylene group of which carbon number ranges from 1 to 6;
a linear, branched, or cyclic alkylenenoxy group of which carbon number ranges from 1 to 6;
a linear, branched, or cyclic alkylenecarbonyloxy group of which carbon number ranges from 1 to 6; and
a direct bond,
P⁵-Sp⁵-R⁸-A¹-(Z-A²)ₙ-R⁷ (2)
where:
R⁷ denotes one selected from the group of:
a —R⁸-Sp⁵-P⁵ group; a hydrogen atom; a halogen atom; a —CN group; a —NO₂ group;
a —NCO group; a —NCS group; a —OCN group; a —SCN group; a —SF₅ group; and
a linear or branched alkyl group of which carbon number ranges from 1 to 18;
P⁵ denotes a radically polymerizable group;
Sp⁵ denotes one selected from the group of:
a linear, branched, or cyclic alkylene group of which carbon number ranges from 1 to 6;
a linear, branched, or cyclic alkyleneoxy group of which carbon number ranges from 1 to 6; and
a direct bond;
the hydrogen atom in R⁷ may be replaced by a fluorine atom or a chlorine atom;
a —CH₂— group in R⁷ may be replaced by a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group, provided that an oxygen atom and a sulfur atom are not adjacent to each other;
R⁸ denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond;
A¹ and A² are identical or different, and each of A¹ and A² denote a 1,2-phenylene group, a 1,3-phenylene group, a 1,4-phenylene group, a naphthalene-1,4-diyl group, a naphthalene-1,5-diyl group, a naphthalene-2,6-diyl group, a 1,4-cyclohexylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, a 1,2,3,4-tetrahydronaphthalene-2,6-diyl group, an indan-1,3-diyl group, an indan-1,5-diyl group, an indan-2,5-diyl group, a phenanthrene-1,6-diyl group, a phenanthrene-1,8-diyl group, a phenanthrene-2,7-diyl group, a phenanthrene-3,6-diyl group, an anthracene-1,5-diyl group, an anthracene-1,8-diyl group, an anthracene-2,6-diyl group, or an anthracene-2,7-diyl group;
a —CH₂— group in A¹ and A² may be replaced by a —O— group or a —S— group, provided that an oxygen atom and a sulfur atom are not adjacent to each other;
one or more hydrogen atoms in the A¹ and A² may be replaced by one selected from the group consisting of:
a fluorine atom; a chlorine atom; a —CN group;
an alkyl group of which carbon number ranges from 1 to 6;
an alkoxy group of which carbon number ranges from 1 to 6;
an alkylcarbonyl group of which carbon number ranges from 1 to 6;
an alkoxycarbonyl group of which carbon number ranges from 1 to 6; and
an alkylcarbonyloxy group of which carbon number ranges from 1 to 6;
Z denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond; and
n is 0, 1, or 2.

2. The method of claim 1, wherein a pretilt angle of the liquid crystal material after formation of the polymer layer ranges from 0 to 3 degrees.

3. The method of claim 1, wherein a mass ratio of the compound A to the compound B in the liquid crystal composition is equal to or more than 0.05.

4. The method of claim 3, wherein the mass ratio is equal to or more than 0.2.

5. The method of claim 1, wherein an amount of the compound A is equal to or more than 0.03 parts by mass per 100 parts by mass of the liquid crystal material.

6. The method of claim 5, wherein the amount of the compound A is equal to or more than 0.06 parts by mass.

7. The method of claim 1, wherein the compound A is represented by the following chemical formula (3): 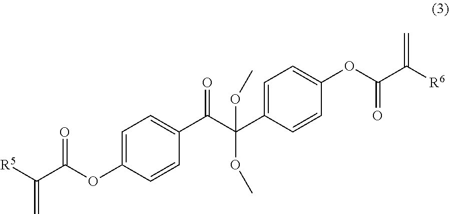
where
R⁵ and R⁶ are an identical or different from each other, and each of R⁵ and R⁶ denote a hydrogen atom or a methyl group.

8. The method of claim 1, wherein the compound B is represented by any of the following chemical formulae (4-1) to (4-5): 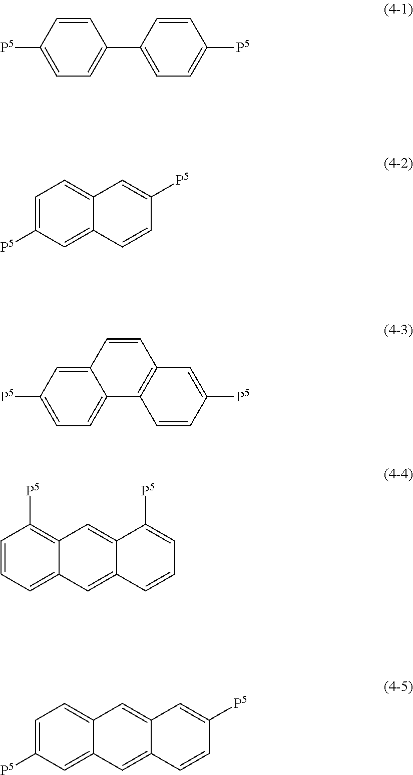
where
P⁵ is an identical or different from each other, and each of P⁵ denotes a radically polymerizable group.

9. The method of claim 8, wherein P⁵ is an identical or different from each other and each of P⁵ is a (meth)acryloyloxy group.

10. A transverse field liquid crystal device, comprising:
a substrate;
a polymer layer formed above the substrate;
a liquid crystal layer including a liquid crystal material above the substrate; and
an electrode formed to apply a transverse field to the liquid crystal layer,
wherein:
the polymer layer is formed by polymerizing a radically polymerizable monomer in a liquid crystal composition including the liquid crystal material and the radically polymerizable monomer; and
the radically polymerizable monomer includes a compound A represented by the following chemical formula (1) and a compound B represented by the following chemical formula (2): 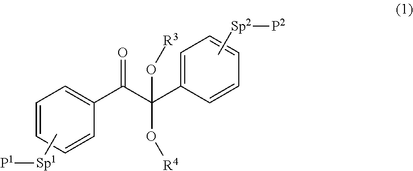
where:
R³ denotes a linear or branched alkyl or alkenyl group of which carbon number ranges from 1 to 4;
R⁴ denotes a linear or branched alkyl or alkenyl group of which carbon number ranges from 1 to 4;
P¹ and P² are an identical or different from each other, and each of P¹ and P² denote a radically polymerizable group;
Sp¹ denotes one selected from the group consisting of:
a linear, branched, or cyclic alkylene group of which carbon number ranges from 1 to 6;
a linear, branched, or cyclicalkyleneoxy group of which carbon number ranges from 1 to 6;
a linear, branched, or cyclic alkylenecarbonyloxy group of which carbon number ranges from 1 to 6; and
a direct bond; and
Sp² denotes one selected from the group consisting of:
a linear, branched, or cyclic alkylene group of which carbon number from 1 to 6;
a linear, branched, or cyclic alkyleneoxy group of which carbon number ranges from 1 to 6;
a linear, branched, or cyclic alkylenecarbonyloxy group of which carbon number ranges from 1 to 6; and
a direct bond,
P⁵-Sp⁵-R⁸-A¹-(Z-A²)ₙ-R⁷ (2)
where:
R⁷ denotes one selected from the group consisting of:
a —R⁸-Sp⁵-P⁵ group; a hydrogen atom; a halogen atom; a —CN group; a —NO₂ group;
a —NCO group; a —NCS group; a —OCN group; a —SCN group; a —SF₅ group; and
a linear or branched alkyl group of which carbon number ranges from 1 to 18;
P⁵ denotes a radically polymerizable group;
Sp⁵ denotes one selected from the group consisting of:
a linear, branched, or cyclic alkylene group of which carbon number ranges from 1 to 6;
a linear, branched, or cyclic alkyleneoxy group of which carbon number ranges from 1 to 6; and
a direct bond;
the hydrogen atom in R⁷ may be replaced by a fluorine atom or a chlorine atom;
a —CH₂— group in R⁷ may be replaced by a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group, provided that an oxygen atom and a sulfur atom are not adjacent to each other;
R⁸ denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond;
A¹ and A² are an identical or different, and each of A¹ and A² denote a 1,2-phenylene group, a 1,3-phenylene group, a 1,4-phenylene group, a naphthalene-1,4-diyl group, a naphthalene-1,5-diyl group, a naphthalene-2,6-diyl group, a 1,4-cyclohexylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, a 1,2,3,4-tetrahydronaphthalene-2,6-diyl group, an indan-1,3-diyl group, an indan-1,5-diyl group, an indan-2,5-diyl group, a phenanthrene-1,6-diyl group, a phenanthrene-1,8-diyl group, a phenanthrene-2,7-diyl group, a phenanthrene-3,6-diyl group, an anthracene-1,5-diyl group, an anthracene-1,8-diyl group, an anthracene-2,6-diyl group, or an anthracene-2,7-diyl group;
a —CH₂— group in A¹ and A² may be replaced by a —O— group or a —S— group, provided that an oxygen atom and a sulfur atom are not adjacent to each other;
one or more hydrogen atoms in the A¹ and A² may be replaced by one selected from the group consisting of:
a fluorine atom; a chlorine atom; a —CN group;
an alkyl group of which carbon number ranges from 1 to 6;
an alkoxy group of which carbon number ranges from 1 to 6;
an alkylcarbonyl group of which carbon number ranges from 1 to 6;
an alkoxycarbonyl group of which carbon number ranges from 1 to 6; and
an alkylcarbonyloxy group of which carbon number ranges from 1 to 6;
Z denotes a —O— group, a —S— group, a —NH— group, a —CO— group, a —COO— group, a —OCO— group, a —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, a —OCO—CH═CH— group, or a direct bond; and
n is 0, 1, or 2.

11. The device of claim 10, wherein a pretilt angle of the liquid crystal material after formation of the polymer layer ranges from 0 to 3 degrees.

12. The device of claim 10, wherein a mass ratio of the compound A to the compound B in the liquid crystal composition is equal to or more than 0.05.

13. The device of claim 12, wherein the mass ratio is equal to or more than 0.2.

14. The device of claim 10, wherein, an amount of the compound A is equal to or more than 0.03 parts by mass or more per 100 parts by mass of the liquid crystal material.

15. The device of claim 14, wherein the amount of the compound A is equal to or more than 0.06 parts by mass.

16. The device of claim 10, wherein the compound A is represented by the following chemical formula (3): 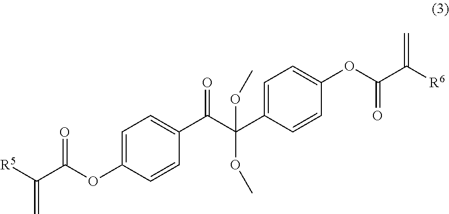
where
R⁵ and R⁶ are an identical or different from each other, and each of R⁵ and R⁶ denote a hydrogen atom or a methyl group.

17. The device of claim 10, wherein the compound B is represented by any of following the chemical formulae (4-1) to (4-5): 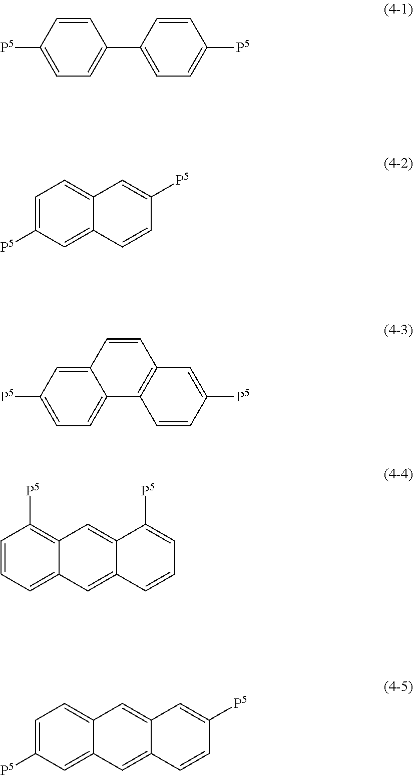
where
P⁵ is an identical or different from each other, and each of P⁵ denotes a radically polymerizable group.

18. The device of claim 17, wherein P⁵ is an identical or different from each other, and each of P⁵ is a (meth)acryloyloxy group.
